(19) United States
(12) Patent Application Publication
(10) Pub. No.: US 2003/0053679 A1
(43) Pub. Date: Mar. 20, 2003

(54) Method and apparatus for imaging workpiece geometry

(76) Inventors: Armin Horn, Renningen (DE); Jochen Krauss, Ditzingen (DE)

Correspondence Address: PEPE & HAZARD, LLP, GOODWIN SQUARE, 225 ASYLUM ST., HARTFORD, CT, 06103, US

(21) Appl. No.: 10/237,200

(22) Filed: Sep. 5, 2002

(30) Foreign Application Priority Data
Sep. 8, 2001 (EP) 01 121 528.2

(51) Int. Cl. G06K 9/36; G06K 9/00

(52) U.S. Cl. 382/152

(57) ABSTRACT

A method and installation for precision imaging of the geometry of workpieces provides relative movement of a CCD detector (13) and the object workpiece (4) in a guided motion. In the process, the CCD detector (13) images the workpiece (4) segment by segment, and the positions of the CCD detector (13) relative to the workpiece (4) and the positions of the imaged workpiece segments are determined. Prior to functional motion of the CCD detector relative to the workpiece (4) to determine its geometry, a rectilinearity and/or angularity calibration is/are performed and, if necessary, a correction value is defined. In at least one subsequent functional motion of the installation, the correction value is factored in for the determination of the positions of the imaged workpiece segments.

### BACKGROUND OF THE INVENTION

This invention relates to a method and apparatus for imaging the geometry of workpieces in which an object-detecting unit and the workpiece are moved relative to each other in a guided functional motion during which the object-detecting unit images the workpiece in segmental fashion.

The functional motion of the object-detecting unit and of the workpiece takes place along at least one track in one guided direction, or along two tracks extending at an angle relative to each other. In the former case, the respective positions of the imaged workpiece segments are determined by the position of the object-detecting unit opposite the workpiece along the path of the directional movement and by the position of the object-detecting unit opposite the workpiece in a transverse direction perpendicular to the direction of guided travel. The transverse position is calculated on the basis of the nominal, i.e., specified, track direction.

In the second case, the geometric determination of the imaged workpiece segments is based on the respective position of the object-detecting unit opposite the workpiece in the direction of the first axis of guided travel as well as on the position of the object-detecting unit opposite the workpiece in the direction of the second axis of guided travel. The angle between the axes of guided travel has a nominal value.

These methods and systems serve the purpose of imaging in composite fashion workpieces or parts thereof which, for instance, due to their dimensions cannot be captured in one single image with adequate resolution. The desired composite image is a mosaic of individual representations of segments of the object, i.e. from subsections of the overall object to be imaged. To that effect it is necessary to define the location of the individually imaged object segments relative to one another. Such positional determination of the object segments is accomplished by way of the detection of the positions occupied by the object-detecting unit at the time the image of the object segment is acquired. A specific position of the object-detecting unit is mapped for each object segment. A precise image of the object or of the object subregion concerned reflecting the actual, true situation necessarily presupposes an exact determination of the positions occupied by the object-detecting unit at the time the object segments are imaged.

Methods and systems of the type mentioned above are described in U.S. Pat. No. 5,184,217 granted Feb. 2, 1993 to J. W. Doering. In this prior art concept, the object-detecting unit in the form of a CCD (charge coupled device) array is mounted on a sliding stage so as to be capable of moving in the direction of a first coordinate axis. The stage on its part, is positioned on a table that holds the workpieces to be scanned, and can move in the direction of a second coordinate axis. The CCD array traveling in the direction of the first coordinate axis and the stage supporting the CCD array and traveling in the direction of the second coordinate axis are each driven by a dedicated DC motor.

For imaging the geometry of a workpiece, the CCD array is moved across the workpiece starting from a reference position. As the CCD array occupies successive positions in the direction of the first coordinate axis, the stage carrying the CCD array is moved in the direction of the second coordinate axis. During these scanning motions, the CCD array, fixed in its position relative to the stage, captures consecutive segments of the workpiece being imaged. The positions of these workpiece segments are defined as a function of the respective positions of the CCD array.

The proviso for each movement of the CCD array is that, as it travels, the CCD array changes direction only in relation to the second coordinate axis while in the direction of the first coordinate axis, an unchanging position of the CCD array is assumed. In other words, the assumption is that the CCD array travels along a perfectly straight path in the direction of the first coordinate axis extending in ideal alignment with the second coordinate axis.

A concurrent assumption is that the second track, i.e., the axis of guided travel of the CCD array in the direction of the second coordinate axis, extends in a direction perfectly perpendicular to the first track, i.e., to the path of the guided, stepwise movement of the CCD array in the direction of the first coordinate axis. On that premise alone could one be assured that, as the CCD array is shifted relative to the second coordinate axis, it is indeed only its coordinates in the direction of the second coordinate axis and not the coordinates of the CCD array in the direction of the first coordinate axis that change.

However, given the fact that, even in highly precise systems of the type discussed, certain variations are caused due to, e.g., manufacturing tolerances or to environmental conditions such as temperature fluctuations. As a result, neither ideal rectilinearity nor perfect squareness of the guide tracks for the CCD array can be assured, and prior art designs encounter deviations between specified and actual positions of the CCD array as it scans the workpiece segments. It follows that the positions of the imaged workpiece segments, the composite of which is supposed to represent the desired total image, are equally flawed. In other words, the resulting total image does not precisely reflect actual conditions.

It is the object of this invention to provide a novel imaging method and apparatus in which there is greater precision in the imaging of the workpiece.

### SUMMARY OF THE INVENTION

It has now been found that the foregoing and related objects may be readily attained in a method for imaging the geometry of workpieces in an installation in which an object-detecting unit (13) and the object workpiece (4) are moved in a guided motion relative to each other and the workpiece (4) is scanned by the object-detecting unit (13) section-by-section. The guided motion of the object-detecting unit (13) and the workpiece (4) takes place along at least one track in the direction of one axis of guided travel (Y-axis), and the respective positions of the scanned workpiece segments are determined by the position of the object-detecting unit (13) adjacent one face of the workpiece (4) along the axis of guided travel (Y-axis). The position of the object-detecting unit (13) relative to the workpiece (4) and along the track in a transverse direction perpendicular to the axis of guided travel (Y-axis) follows a nominal path.

The installation is calibrated prior to functional use for imaging a workpiece by relative movement between the object-detecting unit (13) and a calibration line (14) that extends in a transverse direction in the axis of guided travel (Y-axis) to determine the actual orientation as contrasted to the nominal path of the track. The object-detecting unit (13) scans sections of the calibration line (14) and positional data are determined for scanned sections of the calibration line (14) and the orientation of the calibration line perpendicular to the axis of guided travel (Y-axis). The scanned orientation of the calibration line (14) is compared with its actual path, and at least one correction value is defined on the basis of any detected deviations. After such calibration, in the course of at least one subsequent functional relative motion of a workpiece and object-detecting unit to image the workpiece, the correction value is applied to the determined positions of the imaged workpiece segments.

In one embodiment, the relative motion of the object-detecting unit (13) and the workpiece (4) takes place along a rectilinear track and, correspondingly, calibration is effected by relative movement of the object-detecting unit (13) and a rectilinear calibration line (14).

In a preferred method of imaging, relative to each other the workpiece (4) is scanned by the object-detecting unit (13) section-by-section, by guided bi-directional relative motion of the object-detecting unit (13) and the workpiece (4) along two axes of guided travel (X and Y axes) which extend at an angle (a) relative to each other. The respective positions of imaged workpiece segments are determined by the position of the object-detecting unit (13) adjacent one surface of the workpiece (4) in the direction of one of the axes of guided travel (X-axis) and by the position of the object-detecting unit (13) relative to the workpiece (4) in the direction of the other axis of guided travel (Y-axis), in connection with which a nominal value is calculated for the angle (α) between the axes of guided travel (X and Y axes). Prior to imaging, a calibration procedure uses a calibration span with a first angular position which is aligned in a plane extending parallel to the plane defined by the axes of guided travel (X and Y axes). The calibration span is situated in its first angular position, and the calibration span and the object-detecting unit (13) are moved relative to each other, in the process of which, the object-detecting unit (13) images sections of the calibration span to determine the actual orientation as contrasted with the nominal path. On the basis of the imaged sections of the calibration span, a length (l) of the calibration span is determined. Thereupon the calibration span is realigned at least once more with another angular position in a plane extending parallel to the plane defined by the axes of guided travel (X and Y axes. The calibration span in its additional angular position and the object-detecting unit (13) are moved relative to each other in the process of which the object-detecting unit (13) images sections of the calibration span. On the basis of the imaged sections of the calibration span, a length (l*) of the calibration span is determined, and the lengths (l, l*) of the calibration span thus determined are compared. If necessary, a correction value is defined on the basis of any deviations detected. The correction value is applied to the positions of imaged workpiece segments after factoring in an angle (α) in the course of at least one subsequent functional motion relative to a workiece being scanned.

As can be seen, the improved precision results from the scanning of the geometry of the object workpiece only after a verification of whether the track along which the object-detecting unit and the workpiece to be scanned are moved relative to each other actually extends in the ideal case alignment required for determining the positions of the object-detecting unit relative to the workpiece. If the actual direction of the track deviates from the ideal or specified orientation, correction values are defined which in the subsequent directional movements of the object-detecting unit and the workpiece are factored into the determination of the respective positions occupied by the object-detecting unit relative to the workpiece during the imaging of the workpiece segments. This ensures that each acquired position of the object-detecting unit opposite the workpiece is in fact the correct, actual position. Correspondingly, it also ensures that the workpiece segments imaged by the object-detecting unit are correctly mapped in their actual positions. When the individual workpiece segments are assembled in a mosaic, the result will be a composite image that most accurately reflects the actual geometric conditions.

For appropriate implementation, axial angle verification and calibration technique is also employed. In the event that a deviation of the actual axial angle from the nominal angle is detected, corresponding correction values are factored into the determination of the positions of the object-detecting unit relative to the workpiece as the workpiece segments are imaged and thus into the determination of the positions of the workpiece segments themselves.

In one embodiment the object-detecting unit and the object workpiece are moved relative to each other along only a straight guide track. A stretched wire or comparable string or the like is a simple means for establishing a calibration line that extends in a specified direction.

### BRIEF DESCRIPTION OF THE ATTACHED DRAWINGS

The following description will explain this invention in more detail with the aid of the attached schematic illustrations in which:

FIG. 1 is a partially diagrammatical side elevational view of an apparatus embodying the present invention for the geometric imaging of workpieces;

FIG. 2 is a top view of the apparatus of FIG. 1 with an element for verification of rectilinearity and calibration;

FIGS. 3 and 4 are enlarged sections of FIG. 2 containing an added device for verification of rectilinearity and calibration; and

FIG. 5 is a graphic illustration for visualization of the mathematical and angular relationships.

### DETAILED DESCRIPTION OF THE PREFERRED EMBODIMENT

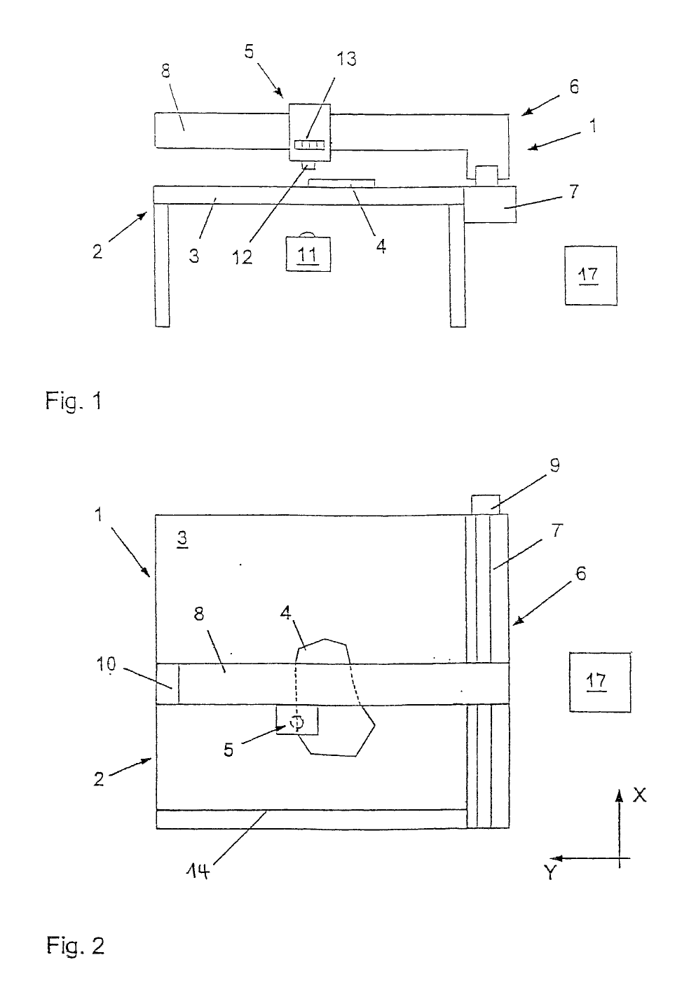

As shown in FIGS. 1 and 2, an installation for imaging the geometry of workpieces in accordance with the present invention is generally designated by the numeral 1, and it includes a coordinate table 2 with a transparent support plate 3 on which a workpiece 4 has been placed. Also included is a CCD camera 5 which, by means of a coordinate guide track assembly 6, can be moved in guided fashion relative to the workpiece 4. As indicated in FIGS. 2-4, the axes of guided travel are referred to as the X-axis and the Y-axis, respectively, covering a horizontal plane across which the CCD camera 5 travels.

The coordinate guide track assembly 6 for the CCD camera 5 consists of an X-rail 7 extending in the direction of the X-axis along the coordinate table 2, and a cantilevered arm 8 that projects from the X-rail 7, in the direction of the Y-axis. For driving the cantilevered arm 8 on the X-rail 7, an X-motor 9 is provided. Similarly, a Y-motor 10 moves the CCD camera 5 along the cantilevered arm 8. The Y-axis defines the direction in which the CCD camera 5 is guided along the cantilevered arm 8.

A flash unit 11, located on the far side of the support plate 3 opposite from the CCD camera 5, travels in synchronization with the CCD camera 5. The flash unit 11 is positioned directly opposite the lens assembly 12 of the CCD camera 5. Located inside the CCD camera 5 behind the lens assembly 12 is an object-detecting unit 13 in the form of an array of CCD elements. Both the CCD camera 5 and the flash unit 11 are of a conventional design.

As seen in FIG. 2, along one side of the support plate 3 of the coordinate table 2 is provided a calibration line 14 is provided. In the example shown, it consists of a stretched wire extending underneath the transparent support plate 3. Since the wire is stretched taut, the calibration line 14 is straight, and extends in the direction of the Y-axis.

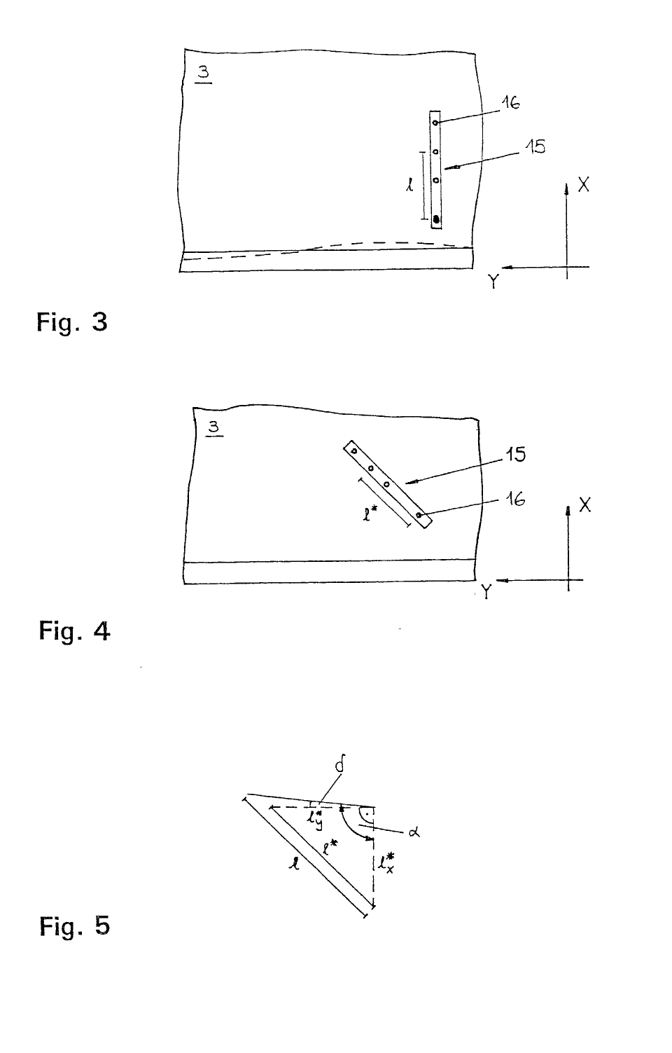

As shown in FIGS. 3 and 4 a reference element 15 is bar-shaped and has several perforations 16 that are variably spaced from one another in the longitudinal direction. If and as needed, that reference bar 15 can be placed and suitably aligned on the support plate 3 of the coordinate table 2. FIGS. 3 and 4 show the reference bar 15 in two different angular positions.

A central processor 17 monitors and controls all of the functions of the installation 1.

Before the irregular outer contour of the workpiece 4 is scanned, the system 1 undergoes a check for rectilinearity and rectangularity and is calibrated.

For verification of rectilinearity and calibration, the cantilevered arm 8 is first moved along the X-axis into a position in which the CCD camera 5 with the object-detecting unit 13 is situated above the calibration line 14. From there, the object-detecting unit 13 moving along the cantilevered arm 8 is guided along the calibration line 14 in the direction of the Y-axis. In the process, the object-detecting unit 13 scans consecutive sections of the calibration line along the Y-axis. That sectional scan is performed in conventional fashion with the flash unit 11 appropriately flashing stroboscopically.

The central processor 17 assembles the scanned sections of the calibration line 14 and the result reflects the course of the calibration line 14 in the form the object-detecting unit 13 has seen it during the scan. This is indicated in exaggerated fashion by the broken line in FIG. 3. The central processor 17 compares that detected course of the calibration line 14 with the stored actual orientation of the calibration line 14. The deviations detected indicate that, unlike the actual orientation of the calibration line 14, the track of the object detecting unit 13 in the direction of the Y-axis does not follow a straight line. The central processor 17 then defines correction values that compensate for the linear deviations of the track of the object-detecting unit 13.

For the verification of rectangularity and calibration, the reference bar 15 is first placed on the support plate 3 of the coordinate table 2 and oriented as shown in FIG. 3 which is essentially parallel to the X-axis. Next, the CCD camera 5 is moved across the reference bar 15. In the process, the object-detecting unit 13 images sections of the reference bar 15. Based on the sections scanned, the central processor 17 determines the distance l between two perforations 16 in the reference bar 15. The spacing between the two perforations 16 defines a calibration span. The distance l between the perforations 16 constitutes the length of the calibration span.

After that length has been determined as described, the reference bar 15 is rotated around any desired pivotal point and aligned in the angular position shown in FIG. 4. In the example illustrated, the reference bar 15 is inclined relative to the X-axis by an angle of about 45°. In this position, the reference bar 15 is scanned by the CCD camera 5. The object-detecting unit 13 again images sections of the reference bar 15. Based on the imaged sections of the reference bar 15, the central processor 17 determines the distance, i.e. the length l*, between the same perforations 16, which distance was determined previously when the reference bar 15 extended in the direction of the X-axis.

The assumption is that the object-detecting unit 13 is guided in precise and error-free fashion in the direction of the X-axis and that no measurement errors occur in the longitudinal measurement of the distance l and l*, respectively. The angular error δ will then be detected when the distance l* is measured.

According to FIG. 5, the result will be:

δ=α−90°,

where α is the angle between the X-axis and the Y-axis, i.e. between the axes of guided travel of the object-detecting unit 13.

Hence, according to the law of cosine:

$$cos α = \frac{{l}^{2} - {l}_{x}^{* 2} - {l}_{y}^{* 2}}{2 {l}_{x}^{*} {l}_{y}^{*}} .$$

To attain highest possible precision, the above-described determination of the lengths, i.e., distances l, l* is made consecutively for different pairs of perforations 16. In each case, an angle α is defined. For the axial angles thus obtained the geometric mean value is determined via

$$a = \frac{{\sum }_{i} {a}_{i} {l}_{I}}{{\sum }_{i} {l}_{I}}$$

This correlates: (i) the sum of all products from the various angles and, with the reference bar 15 aligned in the direction of the X-axis, the associated individual distances between perforations 16, and, (ii), the sum of all distances between perforations measured with the reference bar 15 aligned in the direction of the X-axis. In other words, the individual angles are weighted as a function of the associated distance between perforations as determined when the reference bar 15 is aligned in the direction of the X-axis.

Based on the angle a determined by averaging, the central processor 17 defines the correction values.

Following the checks for rectilinearity and rectangularity and calibration, the CCD camera 5, and with it, the object-detecting unit 13 are moved in a directional pass across the workpiece 4. The imaging is done along the usual swath pattern.

To that effect the cantilevered arm 8 is moved in the direction of the X-axis into successively different positions. In each position of the cantilevered arm 8 in the direction of the X-axis the object-detecting unit 13 travels along the cantilevered arm 8 in the direction of the Y-axis, imaging the scanned swath of the workpiece 4 in segmental fashion. In the process the X-motor 9 and the Y-motor 10 provide feedback information to the central processor 17 as to the travel position of the cantilevered arm 8 in the direction of the X-axis and the progressive positions of the CCD camera 5, i.e. its object-detecting unit 13, in the direction of the Y-axis. The X-motor 9 also serves to define the starting point of the cantilevered arm 8 on the X-rail in the direction of the X-axis. The Y-motor 10 covers the positions of the object-detecting unit 13 in the direction of the Y-axis.

If the track along which the object-detecting unit 13 is moved in the direction of the Y-axis were perfectly straight and if the axial angle a between the X-axis and the Y-axis were exactly 90°, the feedback information provided by the X-motor 9 and the Y-motor 10 would permit the error-free determination of the positions occupied by the object-detecting unit 13 as it scans the segments of the individual strips of the workpiece 4. However, if the installation 1 does not meet that prerequisite due to, e.g., manufacturing related tolerances, the precise determination of the positions of the object-detecting unit 6 requires a correction of the positions established alone on the basis of the feedback information provided by the X-motor 9 and the Y-motor 10. That correction is made with the aid of the correction values acquired in the process of the above described check for rectilinearity and rectangularity and calibration.

As a result, the positions of the object-detecting unit 13 as it scans the segments of the workpiece 4 are determined with a high level of precision. It follows that the positions of the workpiece segments relative to one another are defined with equally high precision. By means of the central processor 17, it is now possible to assemble the workpiece segments into a mosaic which is a complete composite image of the entire workpiece 4 with a highly accurate representation of the actual geometric conditions.

The composite image thus obtained of the workpiece 4 is used in traditional fashion for quality control comparison with production parts or for programming CNC-controlled production machines as a template for parts to be manufactured.

Thus, it can be seen that the apparatus and method of the present invention provides precision imaging of a workpiece as required for other operations.

Having thus described the invention, what is claimed is:

1. In a method for imaging the geometry of workpieces in an installation in which an object-detecting unit (13) and the object workpiece (4) are moved in a guided motion relative to each other and the workpiece (4) is scanned by the object-detecting unit (13) section-by-section, said guided motion of the object-detecting unit (13) and the workpiece (4) taking place along at least one track in the direction of one axis of guided travel (Y-axis) and the respective positions of the scanned workpiece segments are determined by the position of the object-detecting unit (13) adjacent one face of the workpiece (4) along the axis of guided travel (Y-axis) of the guided motion, and in which the position of the object-detecting unit (13) relative to the workpiece (4) along a track in a transverse direction perpendicular to the axis of guided travel (Y-axis), said transverse track following a nominal path, the improvement comprising the calibration of the installation prior to functional relative motion as to a workpiece, in which (i) the object-detecting unit (13) and a calibration line (14) that extends in a transverse direction are moved relative to each other in the axis of guided travel (Y-axis) to determine the actual orientation as contrasted to the nominal path of the track; (ii) the object-detecting unit (13) scans sections of the calibration line (14); (iii) positional data are determined for scanned sections of the calibration line (14) and the orientation of the calibration line perpendicular to the axis of guided travel (Y-axis); (iv) the scanned orientation of the calibration line (14) is compared with its actual path; (v) at least one correction value is defined on the basis of any detected deviations, and after such calibration, in the course of at least one subsequent functional relative motion of a workpiece and object-detecting unit, the correction value is applied to the positions of the imaged workpiece segments detected by the object-detecting unit (13).

2. The workpiece imaging method in accordance with claim 1, wherein the relative motion of the object-detecting unit (13) and the workpiece (4) takes place along a rectilinear track and, correspondingly, calibration is effected by relative movement of the object-detecting unit (13) and a rectilinear calibration line (14).

3. In a method for imaging the geometry of workpieces, in an installation in which an object-detecting unit (13) and the object workpiece (4) are moved in a guided motion relative to each other and the workpiece (4) is scanned by the object-detecting unit (13) section-by-section, said guided motion of the object-detecting unit (13) and the workpiece (4) is a bi-directional movement along two axes of guided travel (X and Y axes) which extend at an angle (α) relative to each other, and the respective positions of imaged workpiece segments are determined by the position of the object-detecting unit (13) adjacent one surface of the workpiece (4) in the direction of one of the axes of guided travel (X-axis) and by the position of the object-detecting unit (13) relative to the workpiece (4) in the direction of the other axis of guided travel (Y-axis), in connection with which a nominal value is calculated for the angle (α) between the axes of guided travel (X and Y axes), the improvement comprising the calibration of the installation prior to functional relative motion as to a workpiece, by (i) providing a calibration span with a first angular position aligned in a plane extending parallel to the plane defined by the axes of guided travel (X and Y axes); (ii) moving the calibration span situated in its first angular position and the object-detecting unit (13) relative to each other, in the process of which, the object-detecting unit (13) images sections of the calibration span to determine the actual orientation as contrasted to the nominal path; (iii) determining on the basis of the imaged sections of the calibration span, a length (l) of the calibration span; (iv) thereupon realigning the calibration span at least once more in another angular position in a plane extending parallel to the plane defined by the axes of guided travel (X and Y) axes; (v) moving the object-detecting unit (13) and the calibration span in another angular position and the process of which the object-detecting unit (13) images sections of the calibration span; (vi) determining on the basis of the imaged sections of the calibration span, a length (l*) of that calibration span; (vii) comparing the lengths (l, l*) of the calibration span thus determined and, if necessary, a correction value is defined on the basis of any deviations detected; and, (viii) in the course of at least one subsequent functional relative motion of a workpiece and the object- detection unit; the correction value is applied to the positions of imaged workpiece segments after factoring in an angle (α).

4. The workpiece imaging method in accordance with claim 3, wherein the functional motion of the object-detecting unit (13) and the workpiece (4) takes place along a track in the direction of a first axis of guided travel (Y-axis), and wherein the object-detecting unit (13) and a calibration line (14) which extends in the direction of a second axis of guided travel (X-axis) along a path corresponding to a nominal track orientation, are moved relative to each other in the direction of the first axis of guided travel (Y-axis), and wherein, during such relative movement, the object-detecting unit (13) images sections of the calibration line (14); wherein, on the basis of the imaged sections of the calibration line (14), the orientation of the line in the direction of the second axis of guided travel (X-axis) is determined; wherein the orientation of the calibration line (14) thus determined is compared to its actual orientation; wherein if and as necessary, at least one correction value is defined on the basis of any detected deviations; and, wherein, in the course of at least one subsequent functional relative motion to a workpiece, the correction value is applied to positions of imaged workpiece segments determined by positions of the object-detecting unit (13) relative to the workpiece (4) direction of the second axis of guided travel (X-axis).

5. An installation for imaging the geometry of workpieces, comprising:
(a) a workpiece support;
(b) an object-detecting unit (13) adjacent one surface of said workpiece support;
(c) means for producing relative movement of the object-detecting unit (13) and an object workpiece (4) on said support along at least one track in a guided motion in a direction of guided travel (Y-axis) during which the object-detecting unit (13) can image segments of the workpiece (4);
(d) a processor for receiving and processing information from the movement producing means and the object-detecting unit and together with said movement producing means and object-detecting unit comprising a position determination subassembly (9, 10, 17), the respective position of the object-detecting unit (13) relative to the workpiece (4) in the direction of guided travel (Y-axis) and the respective position of the object-detecting unit (13) relative to the workpiece (4) in the transverse direction perpendicular to the direction of guided travel (Y-axis) permitting the determination of imaged workpiece segments in a nominal orientation of the guide track of the functional motion perpendicular to the axis of guided travel in the Y-axis; and
(e) a calibration element for the position determination subassembly (9, 10, 17), said calibration element including a calibration line (14) with an actual orientation perpendicular to the direction of guided travel (Y-axis) that corresponds to the nominal orientation of the guide track, said calibration line (14) and the object-detecting unit (13) being movable relative to each other along the track of a functional motion in the direction of guided travel (Y-axis), said object-detecting unit (13) imaging sections of the calibration line (14) during such movement, said position-determination subassembly (9, 10, 17) processing the imaged sections of the calibration line (14) to determine its orientation perpendicularly to the direction of guided travel (Y-axis), the processor comparing the determined orientation of the calibration line (14) with its actual orientation, and, defining at least one correction value necessary on the basis of detected deviations, said position-determination subassembly (9, 10, 17) being operative in at least one subsequent functional motion relative to a workpiece on said support to determine the positions of imaged workpiece segments determined by the positions of the object-detecting unit (13) relative to the workpiece (4) which, in the transverse direction perpendicular to the direction of guided travel (Y-axis) of the guided motion, may have resulted after applying the correction value.

6. The workpiece geometry imaging installation in accordance with claim 5, wherein the object-detecting unit (13) and the workpiece (4) can be moved relative to each other along a straight track and that, for the position-determination subassembly (9, 10, 17), the calibration device includes a taut wire-like calibration line (14) suspended at both ends and stretched in the longitudinal direction.

7. An installation for imaging the geometry of workpieces, comprising:
(a) a workpiece support;
(b) an object-detecting unit (13) adjacent one surface of the workpiece support;
(c) means for producing relative movement of the object-detecting unit (13) and an object workpiece (4) on said support in a guided biaxial motion along two axes of guided travel (X and Y axes) which extend at an angle (α) to each other, the object-detecting unit (13) being capable of imaging the workpiece (4) segment by segment,
(d) a processor for receiving and processing information from the movement producing means and the object-detecting unit and together with said movement producing means and object-detecting unit comprising a position determination subassembly (9, 10, 17), by which the positions of the imaged workpiece segments can be determined on the basis of the respective position of the object-detecting unit (13) relative to the workpiece (4) in the direction of one of the axes of guided travel (X-axis) and on the basis of the respective position of the object-detecting unit (13) relative to the workpiece (4) in the direction of the other axis of guided travel (Y-axis) after allowing a nominal value for the angle (α) between the axes of guided travel in the X-axis and Y-axis); and
(e) a calibration element for the position determination subassembly (9, 10, 17), said calibration device including a calibration span that can be aligned in at least one plane extending parallel to a plane defined by the axes of guided travel in the X-axis and Y-axis in different angular positions, said object-detecting unit (13) and the calibration span being movable relative to each other, in a movement corresponding to a functional motion for imaging of a workpiece, the object-detecting unit (13) imaging sections of the calibration span, said processor determining a length (l, l*) of the calibration span by data from the position determination subassembly (9, 10, 17) and the individually imaged sections of the calibration span, and comparing the lengths (l, l*) thus determined to define at least one correction value on the basis of any detected deviations, said position determining subassembly being operative in at least one subsequent functional motion relative to a workpiece to determine the positions of the imaged workpiece segments after allowing for an angle (α) between the axes of guided travel in the X and Y axes by applying the correction value.

8. The workpiece geometry imaging installation in accordance with claim 7, wherein the calibration device for the position-determination subassembly (9, 10, 17) includes a calibration line (14) which extends in the direction of the first axis of guided travel (Y-axis) while having a nominal orientation in the direction of the second axis of guided travel (X-axis), the object-detecting unit (13) and the calibration line (14) being movable relative to each other in the direction of the calibration line (14)), said controller processing data from the position-determination subassembly (9, 10, 17) and the imaged sections of the calibration line (14) to determine the orientation of the calibration line in the direction of the second axis of guided travel (X-axis), the orientation of the calibration line (14) thus determined being compared with its actual orientation, to define at least one correction value on the basis of any detected deviations, the position determination subassembly (9, 10, 17) in at least one subsequent functional motion relative to a workpiece determining the positions of the imaged workpiece segments on the basis of positions of the object-detecting unit (13) relative to the workpiece (4) which have resulted in the direction of the second axis of guided travel (X-axis) after applying the correction value.

9. The workpiece geometry imaging installation in accordance with claim 7 wherein the calibration line (14) is a wire-like element extending in the direction of the first axis of guided travel suspended at both ends and stretched in the longitudinal direction.
